(19) United States
(12) Patent Application Publication
(10) Pub. No.: US 2019/0221135 A1
(43) Pub. Date: Jul. 18, 2019

(54) EDUCATIONAL METHOD AND APPARATUS

(71) Applicant: Cynthia Crocker, Philadelphia, PA (US)

(72) Inventor: Cynthia Crocker, Philadelphia, PA (US)

(21) Appl. No.: 16/368,023

(22) Filed: Mar. 28, 2019

Related U.S. Application Data
(63) Continuation-in-part of application No. 15/263,211, filed on Sep. 12, 2016, now abandoned.

(51) Int. Cl. G09B 19/02; G09B 7/00

(52) U.S. Cl. CPC G09B 19/02; G09B 7/00

(57) ABSTRACT

A method of teaching multiplication is shown and described. The method may be practiced as a group endeavor for classroom settings, or as a game in the absence of teacher participation. The method uses partially completed multiplication tables which provide either multiplicands and multipliers, thereby obliging students and players to furnish corresponding products, or alternatively, display products and either multiplicands or multipliers, obliging students to furnish the missing element. Students learn by viewing all three elements. Students practice by completing multiplication operations using the partially completed multiplication tables.

### CROSS-REFERENCE TO RELATED APPLICATION

This application is a Continuation-in-Part (CIP) of U.S. patent application Ser. No. 15/263,211 filed Sep. 12, 2016, the disclosure of which is incorporated herein by this reference.

### FIELD OF THE INVENTION

The present invention relates to apparatus and method for training children in multiplication. The method may be practiced as a game.

### BACKGROUND OF THE INVENTION

Teaching multiplication, particularly, multiplication tables, has traditionally been performed by rote verbal memory drills. It may be preferable to utilize methods associated with amusement and games, and relying upon sight for learning rather than relying on auditory inputs.

### SUMMARY OF THE INVENTION

The present invention provides a method of instructing young learners in multiplication tables employing a game or game atmosphere. When practiced as an academic exercise, an authority such as a teacher leads queries requiring students to respond en masse with answers to individual multiplication queries. The teacher may then make a transition where the queries are practiced in the manner of games, without active teacher guidance.

This process enables children to rely on visual memory and not on oral memory.

Lesson and game apparatus are similar, using incomplete multiplication tables which are completed by the students.

The present invention provides improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a representation of a partially completed multiplication table which may be utilized with the novel method, according to one aspect of the invention;

FIGS. 2-5 are representations of variations of the partially completed multiplication table of FIG. 1;

FIG. 6 is a plan view of an accessory which may be utilized with any of the partially completed multiplication tables usable in the novel method, according to further implementations of the method;

FIG. 7 is a representation of a partially completed multiplication table setting forth time restrictions, according to yet another implementation of the method;

FIG. 8 is a representation of still another partially completed multiplication table usable with still another implementation of the method; and

FIG. 9 is a representation of a partially completed multiplication table usable with a further implementation of the method.

### DETAILED DESCRIPTION

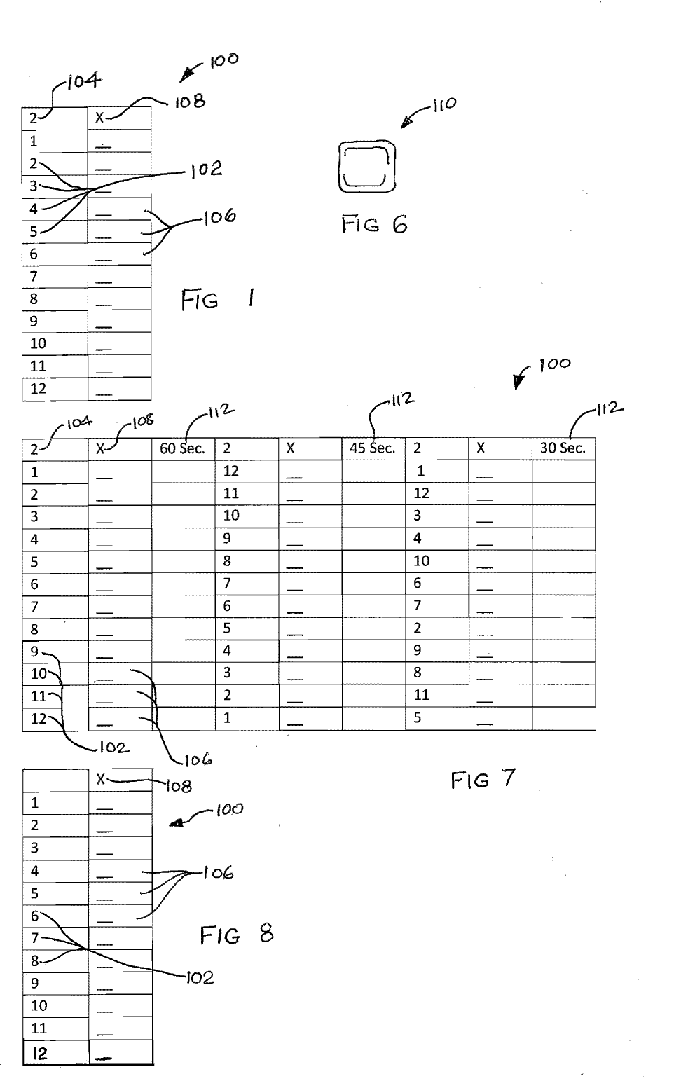

Referring first to FIG. 1, according to at least one aspect of the invention, there is shown an exemplary partially completed multiplication table 100. Partially completed multiplication table 100 displays a plurality of multiplicands 102, a multiplier 104, answer spaces 106 corresponding to each multiplicand 102, and optionally, an indicator 108 of multiplication.

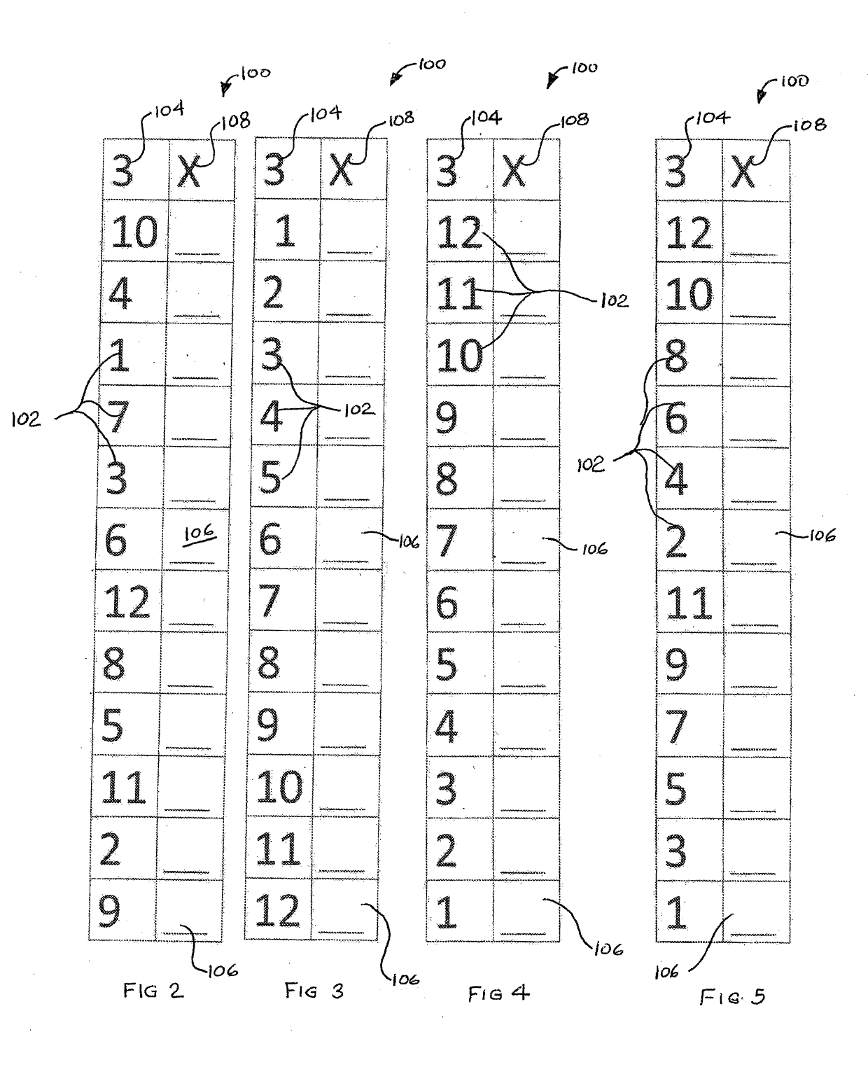

For an actual lesson, a method of using multiplication tables 100 utilizes apparatus for teaching multiplication tables to students, the apparatus comprising a plurality of partially completed multiplication tables 100, wherein each multiplication table 100 includes a plurality of multiplicands 102, a multiplier 104, and for each multiplicand 102, a corresponding answer space 106. Each one of the plurality of partially completed multiplication tables 100 lists multiplicands 102 in an order different from every other one of the partially completed multiplication tables 100. As seen in FIGS. 2-5, one of partially completed multiplication tables 100 lists multiplicands 102 in ascending order of magnitude (FIG. 3); one of partially completed multiplication tables 100 lists multiplicands 102 in descending order of magnitude (FIG. 4); one of partially completed multiplication tables 100 lists multiplicands 102 in an irregular order (FIG. 2); and one of partially completed multiplication tables 100 lists multiplicands 102 in a first group of even value multiplicands 102 and an adjacent group of odd value multiplicands 102 (FIG. 5). Providing different orders of multiplicands 102 assures that students learn to rely on multiplication to derive answers to queries, and do not merely associate answers with positions on partially completed multiplication tables 100.

Each corresponding answer space 106 may be blank, and is of dimensions enabling a product of multiplicands 102 and multiplier 104 to be entered manually thereon for each associated pair of multiplicands 102 and multiplier 104. The option of writing products in answer spaces 106 may be used when students practice the exercise individually as a game. Alternatively, answer spaces 106 may permanently bear answers. Where the latter occurs, or if desired with blank answer spaces 106, the apparatus may further comprise a plurality of opaque panels 110 (shown in FIG. 6) dimensioned and configured to cover one of the corresponding answer spaces 106. Opaque panels 110 may be colored or may bear pictorial devices or other indicia (none shown) if desired.

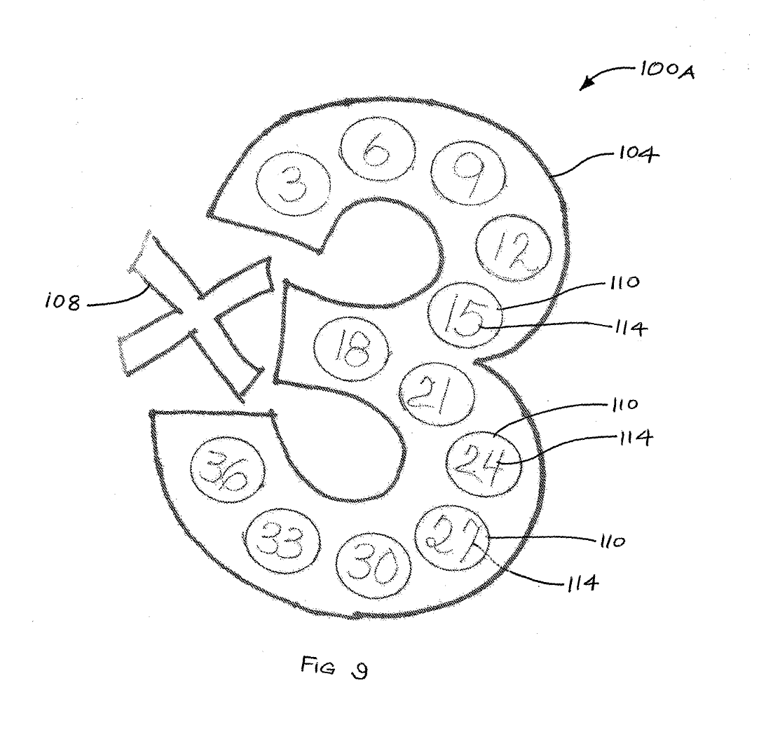

In a variation intended for more advanced classroom play of the game, and referring to FIG. 7, at least one of partially completed multiplication tables 100 displays a time limit 112. When utilizing the partially completed multiplication table 100 of FIG. 7, each set of multiplication exercises (shown in vertical columns) is undertaken in progressively reduced time limits.

FIG. 8 shows a minor variation of a partially completed multiplication table 100 wherein a set or invariable multiplier 104 is not preprinted thereon. The partially completed multiplication table 100 of FIG. 8 is readily adapted to different multipliers 104.

In summary, in some implementations, exercises and similar games utilize multiplication tables 100 revealing multipliers 104 and multiplicands 102. In these implementations, students must be able to determine (and announce, where appropriate) products of multipliers 104 and multiplicands 102.

In other implementations, partially completed multiplication tables 100 may reveal multipliers 104 and products 114. In these implementations, students must determine and furnish (e.g., announce) multiplicands 102. An example of the latter form of partially completed multiplication table 100A is shown in FIG. 9. Partially completed multiplication table 100A include multipliers 104 and indicator 108 of multiplication, just as with partially completed multiplication tables 100.

With partially completed multiplication tables 100, because it is desired to teach multiplication by sight memorization, products are initially hidden by opaque panels 110 or alternatively, are not present. Where products are present, opaque panels 110 are removed to reveal answers, which are then memorized by students. Opaque panels 110 are replaced to conceal answers which have just been viewed.

In exemplary play, students may roll dice (not shown) to determine order of play of students. Students may play individually or in pairs. The first student to roll a predetermined die combination (e.g., doubles) removes that opaque panel 110 covering the multiplier having a value magnitude of one. Subsequent rolls of dice or utilization of other chance devices determine order of play. At each turn, a student removes and retains an opaque panel 110 upon announcing a correct product (when using partially completed multiplication table 100), or a correct multiplier (when using partially completed multiplication table 100A).

Opaque panels 106 may be retained as score markers after a multiplicand or multiplier is announced by the student or player in the course of play.

Alternatively, opaque panels 106 may merely conceal correct answers appearing on answer spaces 106.

Exercises may be conducted with teacher supervision, or alternatively, as a game (e.g., using partially completed multiplication tables 100 as seen in FIG. 7) without direct participation by a teacher. In either type of implementation of the novel method of teaching, learning occurs by sight memory.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. Apparatus for teaching multiplication tables to students, the apparatus comprising a plurality of partially completed multiplication tables, wherein
each said multiplication table includes a multiplicand, a multiplier, and for each multiplicand, a corresponding answer space, and
each one of the plurality of partially completed multiplication tables lists the multiplicands in an order different from every other one of the partially completed multiplication tables.

2. The apparatus of claim 1, wherein each said corresponding answer space is blank, and is of dimensions enabling a product of the multiplicands and the multiplier to be entered manually thereon for each associated pair of multiplicands and multiplier.

3. The apparatus of claim 1, further comprising a plurality of opaque panels dimensioned and configured to cover one of the corresponding answer spaces.

4. The apparatus of claim 1, wherein one of the partially completed multiplication tables lists multiplicands in ascending order of magnitude.

5. The apparatus of claim 1, wherein one of the partially completed multiplication tables lists multiplicands in descending order of magnitude.

6. The apparatus of claim 1, wherein one of the partially completed multiplication tables lists multiplicands in an irregular order.

7. The apparatus of claim 1, wherein one of the partially completed multiplication tables lists multiplicands in a first group of even value multiplicands and an adjacent group of odd value multiplicands.

8. The apparatus of claim 1, wherein at least one of the partially completed multiplication tables displays a time limit.
